(19) United States
(12) Patent Application Publication
(10) Pub. No.: US 2006/0187307 A1
(43) Pub. Date: Aug. 24, 2006

(54) Object boundary fitting system and method thereof for an digital data presenter

(76) Inventor: Chung-Hao Wu, JhuBei City (TW)

Correspondence Address: HERBERT L. ALLEN;ALLEN, DYER, DOPPELT, MILBRATH & GILCHRIST, P.A., 255 SOUTH ORANGE AVENUE, SUITE 1401, P. O. BOX 3791, ORLANDO, FL, 32802-3791, US

(21) Appl. No.: 11/344,282

(22) Filed: Jan. 31, 2006

(30) Foreign Application Priority Data
Feb. 17, 2005 (TW) 94104718

(51) Int. Cl. H04N 5/225

(52) U.S. Cl. 348/207.11

(57) ABSTRACT

An object boundary fitting system and a method thereof for an digital data presenter are provided. The system contains a camera system and a control system which contains an automatic fitting object boundary controller. The first step of the provided method is to automatically set an adjustable camera scope of a camera system to a relatively largest camera scope. Then, a specific boundary of a specific object is defined as an image scope through the camera system, the specific boundary is compared to the adjustable camera scope, and the adjustable camera scope is matched to the specific object by manual selection.

### FIELD OF THE INVENTION

The present invention relates to a digital data presenter apparatus, particularly to a digital data presenter which has an object boundary fitting system and to an object boundary fitting method therefor.

### BACKGROUND OF THE INVENTION

Please refer to FIG. 1 which is a three-dimensional schematic view of a conventional digital data presenter machine. Now, the commercially available machine 1 contains a base 10 and a camera system 2 which is hanged and fixed above the base 10 by an arm 20. The camera system 2 contains a lens 22. A plurality of controlling buttons 12 for controlling the operation of the conventional digital data presenter machine are mounted on the base 10. The digital data presenter machine 1 further contains a light emitting panel 14 on the base 10. Lights emitted therefrom will pass through the object (which is not shown in FIG. 1 and is generally a transparent sheet) and then will be projected and received in the camera system 2.

The conventional digital data presenter machine 1 is generally used and put on a desk which is not shown in FIG. 1. A document having a paper size of A4 (297 mm×210 mm) is typically applied in most situations. The backlight panel 14 on which the document is placed also has an A4 size or slightly larger, so that the backlight panel 14 can cover the whole area of the document.

Please refer to FIG. 2 which shows the length-to-width ratios of the document 3 and a camera scope 4 of the digital data presenter machine 1, respectively. Typically, the sensor component used in the digital data presenter machine 1, such as a CCD (charge-coupled device) sensor or a CMOS sensor, is shaped in rectangular and the length-to-width ratio thereof is generally equal to 4:3 with a value of 1.333. Therefore, the camera scope 4 with a long boundary 42 and a short boundary 40 is obtained by using the lens 22 of the camera system 2 (Please refer to FIG. 1), and the ratio thereof also equal to 1.333. But, the ratio of the long side 32 to the short side 30 for the document 3 having a paper size of A4 is 1.414. Therefore, the camera scope 4 of the sensor component can not completely encompass the whole image scope of the document 3 having a paper size of A4. Furthermore, since the long boundary 42 of the camera scope 4 obtained by using the sensor component in the digital data presenter machine 1 is parallel to the short side 30 of the document 3, and the short boundary 40 of the camera scope 4 is parallel to the long side 32 of the document 3, it is thus difficult for the sensor component to cover the whole document 3 even the whole area of the sensor component is used.

Because the respective length-to-width ratios of the sensor component and the document are different and the long-side/short-boundary and short-side/long-boundary are not corresponding, in order to let the camera scope 4 completely cover the document 3, the focus length of the lens 22 shall be changed, i.e. zooming, by pressing the controlling button 12. Then, the camera scope 4 is changed, accordingly. For changing the camera scope 4, the long boundary 42 of the camera scope 4 shall be matched with the short side 30 of the document 3, or alternatively the short boundary 40 of the camera scope 4 shall be matched with the long side 32 of the document 3. Such a manual operation for zooming the camera scope 4 is inconvenient and time-consuming because the user must watch the screen (which is not shown in FIG. 1) carefully to make sure that the change of the camera scope 4 is not overrun.

From the above, for overcoming the mentioned drawbacks in the field of digital data presenter machine, there is a need to provide an apparatus for swiftly changing the camera scope and its method therefor so as to make the zooming operation more convenient and faster.

### SUMMARY OF THE INVENTION

It is a first aspect of the present invention to provide a method for fitting an adjustable camera scope of a camera system to an object boundary for an digital data presenter, wherein the digital data presenter having the camera system is used for digitally presenting an object, the method including steps of: (1) setting said adjustable camera scope of said camera system to a predetermined camera scope;

(2) defining a smallest area encompassing said object as an image scope through said camera system;

(3) comparing said image scope to said adjustable camera scope; and

(4) fitting said adjustable camera scope to said image scope.

Preferably, the camera system has a sensor component, and the relatively largest camera scope is formed when the sensor component is lifted to a relatively highest position.

Preferably, the camera system has a lens and the relatively largest camera scope is formed when a vision field of the lens is set at a relatively widest view angle.

Preferably, the camera system further has a lens, and the relatively largest camera scope is formed when a focal length of the lens is equal to a relatively smallest length.

Preferably, the relatively largest camera scope is the scope of the base illuminated on the digital data presenter.

Preferably, the specific boundary of the specific object defined as the image scope is a relatively largest scope.

Preferably, the image scope is extended in a long axis direction and a short axis direction, a long boundary of the adjustable camera scope is compared to a short axis of the image scope and a short boundary of the adjustable camera scope to a long axis of the image scope.

Preferably, the manual operation is performed to match the adjustable camera scope to the image scope of the specific object, and to select the short boundary of the adjustable camera scope covering a long axis of the specific object.

Preferably, the long axis of the specific object is a long axis of a base of the digital data presenter.

Preferably, the long boundary and the short boundary of the camera scope is calculated based on a long axis and a short axis of a sensor component contained in the camera system.

According to a second aspect of the present invention, this invention provides a system for fitting a camera scope to a specific object in an digital data presenter comprising: a base; a camera system positioned above the base and comprising a sensor component and a lens; and a control system for controlling the digital data presenter—and comprising an automatic fitting object boundary controller for a adjustable camera scope of the camera system covering a specific object.

Preferably, the automatic fitting object boundary controller contains a boundary interchangeable switch for switching between states of object boundary fitting comprising: a first state under which the camera scope matches a long axis of the specific object; and a second state under which the camera scope matches the short axis of a specific object; wherein the first state and the second state are switched by the automatic fitting object boundary controller.

Preferably, the best boundary interchangeable switch is a press button by pressing which the first state and the second state are alternatively switched.

Preferably, the boundary interchangeable switch is a push button switch having a first position and a second position, wherein the first position represents the first state, and the second position represents the second state.

The foregoing and other features and advantages of the present invention will be more clearly understood through the following descriptions with reference to the drawings, wherein:

### BRIEF DESCRIPTION OF THE DRAWINGS

FIG. 1 is a three-dimensional schematic view showing the digital information projecting machine according to the prior art;

FIG. 2 is a schematic view showing the length-to-width ratio of the document and the camera scope 4 of the sensor component;

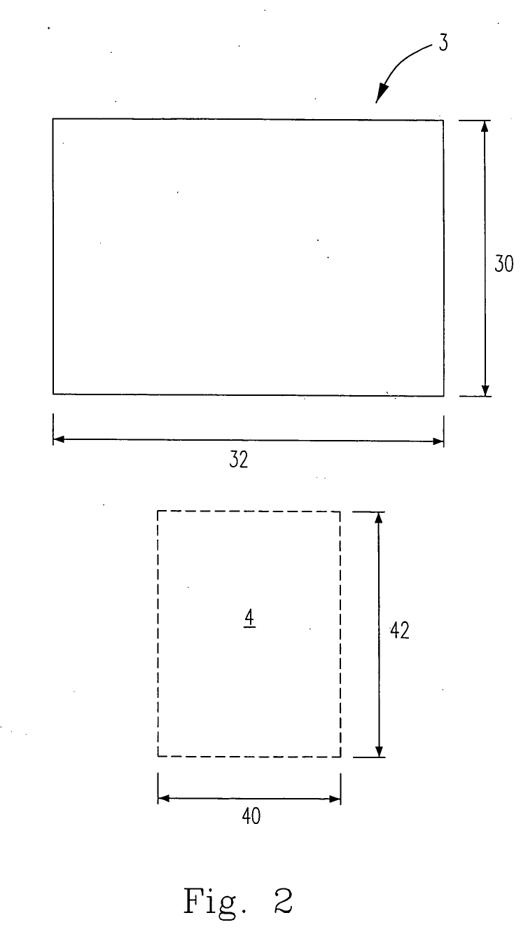

FIG. 3 is a three-dimensional schematic view showing a digital data presenter according to the present invention;

FIG. 4 is a flowchart diagram showing steps and process of boundary fitting method of the digital data presenter of the present invention;

FIG. 5. is a schematic view showing the fitting between the adjustable camera scope and the object boundary of the present invention;

FIG. 6. is another schematic view showing the fitting between the adjustable camera scope and the object boundary of the present invention;

FIG. 7 is a schematic view showing application of the present invention to an irregular object;

FIG. 8 is a schematic view showing a image received in the object presenting device and projected on a screen according to the present invention; and

FIG. 9 is a schematic view showing various examples of interchangeable switches of the digital data presenter according to the present invention

### DETAILED DESCRIPTION OF THE PREFERRED EMBODIMENT

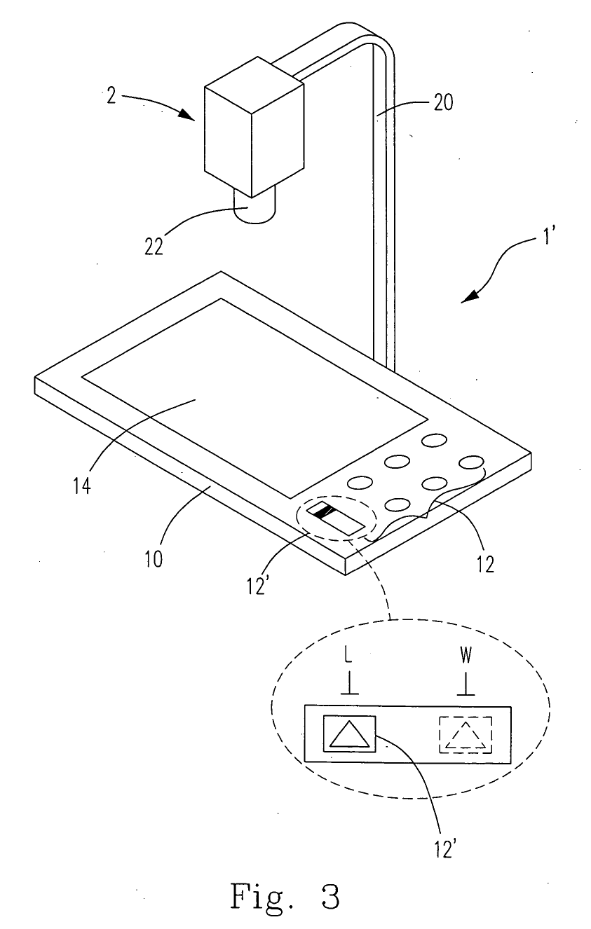

Please refer to FIG. 3. FIG. 3 is a three-dimensional schematic view showing the digital data presenter 1′ of the present invention containing a base 10, a camera system 2 which is hanged and fixed above the base by a arm 20 and containing a lens 22 and a sensor component which is located in the camera system 2 and which is not shown in FIG. 3. The digital data presenter 1′ of the present invention contains a control system (which is not shown in FIG. 3), and a plurality of controlling buttons 12 are mounted on the base 10 and used as the interface between a user and the controlling system for controlling the operation of the digital data presenter 1′. A backlight panel 14 can actively emits light from the base 10, through an object (which is not shown and generally is a sheet-like object, such as paper, projecting sheet), and projected and received in the camera system 2.

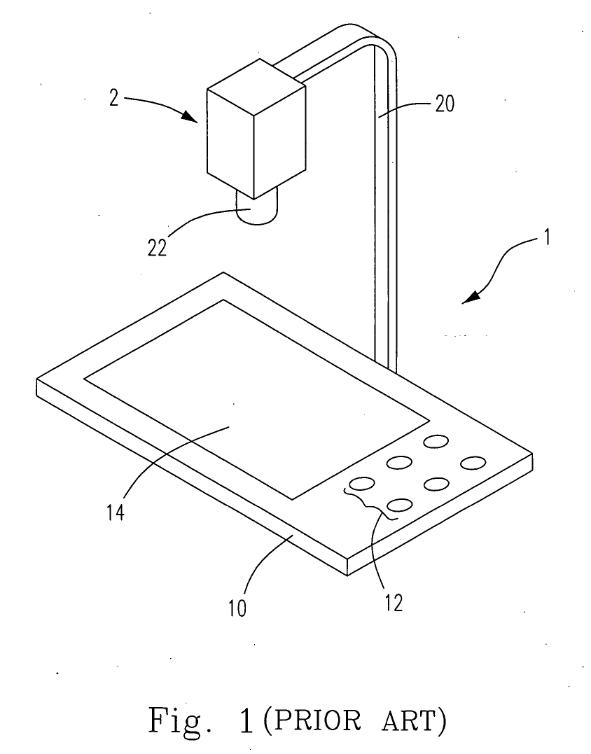

The main difference between the conventional digital data presenter machine 1 (Please refer to FIG. 1) and the digital data presenter 1′ of the present invention is that a plurality of controlling button 12 of the digital data presenter 1′ of the present invention contains a interchangeable switch 12′. Two interchangeable alternatives can be chosen. One of the alternatives is to match to the whole length L and the other is to match to the whole width W. In this way, after the interchangeable switch 12′ is pressed, the adjustable camera scope 4 can change from fitting to the whole length L to fitting to the whole width W. On the contrary, it is true. Therefore, digital data presenter 1′ of the present invention is convenient to use and usage efficiency is high.

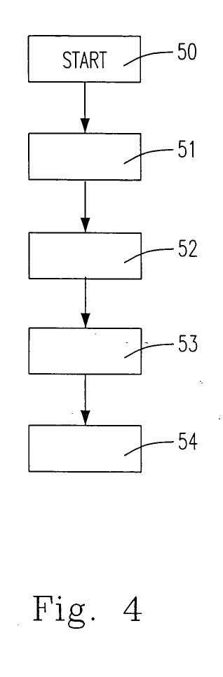

Please refer to FIG. 4 which is the object boundary fitting method and procedures of the digital data presenter 1′ of the present invention demonstrating the actions of the digital data presenter 1′ of the present invention and steps of the used method. The first step is to start the machine 50 in order that the camera system 2 starts to camera. The steps of the method of the present invention contains the steps of: the first step 51: automatically setting a adjustable camera scope of the camera system to the relatively largest one; the second step 52: defining a specific boundary of a specific object as the image scope by camera work of the specific object through the camera system; the third step 53: comparing the specific boundary to the adjustable camera scope; and the fourth step 54: fitting the camera scope to the specific boundary of the specific object by manual operation.

As to the first step 51, if the lens 22 is a zooming lens, the focal length of the lens 22 is regulated to the relatively smallest one so that the viewing angle of the camera system becomes to be the relatively largest one. Alternatively, the sensor component is lifted to the relatively highest level position. The general method is to lift the position of the camera system to the highest one. For the base 10 having illumination function, its illumination range generally is fixed. Therefore, the area of the base 10 or the illumination range of the base 10 is the relatively largest camera scope.

As to the second step 52, the relatively largest one of the scope coverable by the image exhibited by the specific object is the object boundary. For further demonstration, the object (which is not shown in the FIG. 3) put on the base 10 generally is paper document. But, sometimes the object is not a paper document having an A4 size. Sometimes the object is a book object. The exhibited object boundaries are not the same when the book object is folded or unfolded.

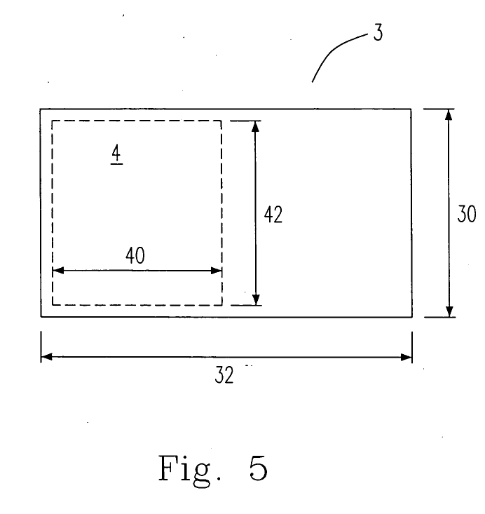

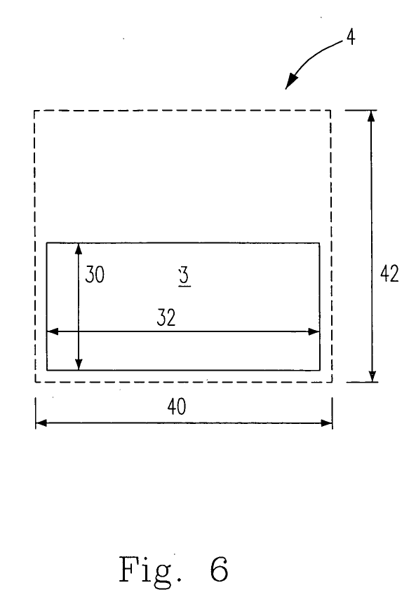

Please refer to FIG. 5 and FIG. 6 which are the match schematic view of the camera scope and the object boundary. Please refer to FIG. 5 firstly. When the long boundary 42 of the camera scope 4 is in alignment with the short side 30 of the document 3, the short boundary 40 of the camera scope 4 can not completely cover the long side 32 of the document 3. In this way, in view of FIG. 5, part of document 3 at the right side can not be covered by camera scope 4. Please refer to FIG. 6 secondly. When the short boundary 40 of the camera scope 4 is in alignment with the long side 32 of the document 3, the long boundary 42 of the camera scope 4 exceeds the short side 30 of the document 3. But, the image of the document 3 can be completely received by the sensor component. From the above, when the long boundary of the camera scope is correspondent to the short side of the document and short boundary of the camera scope is correspondent to the long side of the document, and if the length of the short boundary of the camera scope is regulated to be in alignment with the long side of the document, the camera scope can completely encompass all parts of the document. Furthermore, in view of FIG. 5 to set the long boundary 42 of the camera scope 4 in alignment with the short side of a base (not shown in FIG. 3) of the digital data presenter of the present invention, or in view of FIG. 6 to set the short boundary 40 of the camera scope 4 in alignment with the long side of a base (not shown in FIG. 3) of the digital data presenter is one controlling mode of the alternatives of the method. The mechanism of controlling the fitting with long side or the short side can be integrated into the hardware so as to obtain the effect of simplification of the system of the digital data presenter.

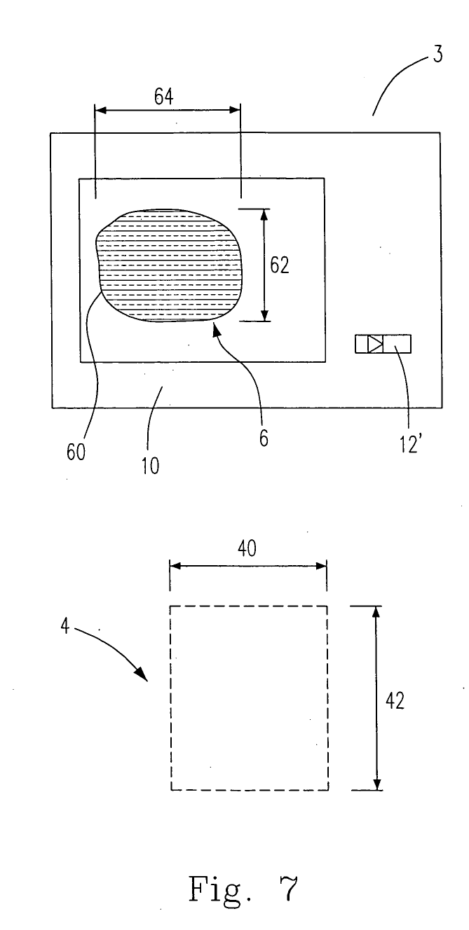

Please refer to FIG. 7 which is a schematic diagram demonstrating the application of the present invention to the irregular object. FIG. 7 shows an irregular object 6 is put on the digital data presenter 1′ of the present invention. The boundaries of many damaged deficient calligraphies, paintings and ancient books are irregular, particularly if the irregular object is a parchment document. The technique of the present invention can receive the image of the boundary 60 of the irregular object 6 and define the boundary 60 by means of technique that when the camera scope of the sensor component, as many exhibited images are received in the sensor component, is the largest one, for a plurality of pixels of the irregular object exhibited in the sensor component, the pixels which can construct the largest area is found, then the combination of the pixels are the boundary 60.

The boundary 60 and the area within it is the image scope. The boundary 60 can be divided into an object long axis 64 and an object short axis 62, while the camera scope has long boundary 42 and short boundary 40. In the embodiment, because the direction of the object long axis 64 and the direction of the short boundary 40 of the camera scope 4 are the same. In order to make sure that the camera scope 4 can cover the whole irregular object 6, i.e. the short boundary 40 of the camera scope 4 at least can cover the object long axis 64 of the irregular object 6, the camera scope 4 can completely encompass the irregular object 6. For letting the camera scope 4 completely encompass the irregular object 6, the short boundary 40 of the camera scope 4 shall comply with object long axis 64 through regulation of the focal length of the lens 22 or lifting of the height of the sensor component (not shown in FIG. 7) in the camera system 2. If the long boundary 42 of the camera scope 4 just complies with object short axis 62, every portion of the pixels in the sensor component in the camera system 2 (not shown in FIG. 7) is sufficiently utilized.

The meaning that the long boundary 42 or short boundary 40 of the camera scope 4 complies with the object long axis (i.e. the length L of the irregular object 6) or object short axis (i.e. the width W of the irregular object 6) is to view the object 6 at the largest magnification so as to obtain the whole image of the object. By the above comparison action, the data obtained can be stored in the digital data presenter 1′ of the present invention. Accordingly, when the interchangeable switch 12′ is operated, the digital data presenter 1′ shall swiftly switch between two states, i.e. the first state to match with the length L of the irregular object and the second state to match with the width W of the irregular object.

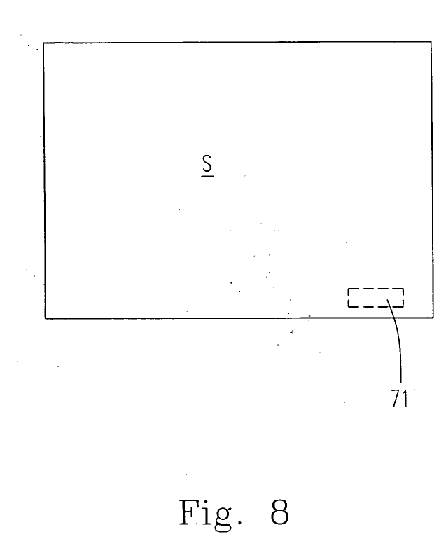

Please refer to FIG. 8 which shows a schematic view of an image received in the digital data presenter 1′ and projected to the screen. At the right low corner of the screen S, there is a state area 71 in which the state of the digital data presenter 1′ which is to match with the length L or to match with the width W is shown to remind the user to know the usage state of the digital data presenter. Certainly, the position of the state area 71 projected on the screen can be altered depending upon the inclination of the user.

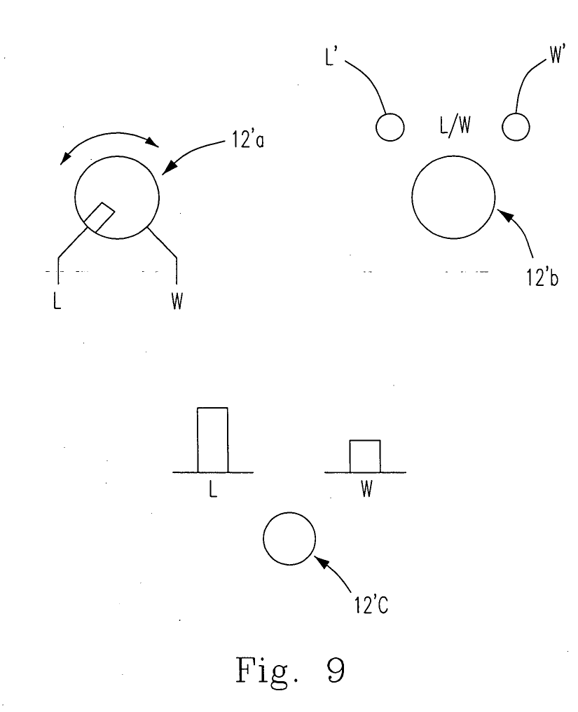

Please refer to FIG. 9 which is a schematic view of various kinds of interchangeable switches used in the digital data presenter of the present invention. The interchangeable switch 12′a is a rotary switch the selection states of which have two states. One selection state is to match with the length L and the other is to match with the width W. The interchangeable switch 12′b is a touch switch. When the touch switch is pressed by a touch movement, the state to match with the length L is transformed into the state to match with the width W. When touched again, the state to match with the width W is transformed into the state to match with the length L. An indicator L′ is mounted to show the state to match with the length L and an indicator W′ to show the state to match with the width W in order to let the user make sure the usage state. The interchangeable switch 12′c is a push button switch. When the push button switch 12′c is lifted, it belongs to the state to match with the length L. When the push button switch 12′c is pressed down, it belongs to the state to match with the width W. Moreover, the state to match with the width W or state to match with the length L may be chosen by using a software control. For example, to push-down menu is used as control way to control the camera scope to switch between the state to match with the width field or to match with the length field. The above selection action is the movement to start a state to match the length or to start a state to match with the width.

Accordingly, as to the digital data presenter which has an object boundary fitting system and its method thereof of the present invention, in the field of digital data presenting machines, no matter it is the digital data presenter as shown in FIG. 3 or the hang-up type presenting machine, it can provide enormous help to let the user switch change the camera scope. Then, the camera scope can swiftly switch between the two states, i.e. the state to match with the length of the object and the state to match with the width of the object without the necessity of manual zooming operation to conventional digital information projecting machine to switch. The convenience of the presenting machine of the present invention is hardly to be said to be small.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A method of fitting an adjustable camera scope of a camera system to an object boundary for an digital data presenter, wherein said digital data presenter having said camera system is used for digitally presenting an object, comprising steps of:
(1) setting said adjustable camera scope of said camera system to a predetermined camera scope;
(2) defining a smallest area encompassing said object as an image scope through said camera system;
(3) comparing said image scope to said adjustable camera scope; and
(4) fitting said adjustable camera scope to said image scope.

2. The method according to claim 1, wherein said camera system comprises a sensor component and a relatively largest camera scope of said predetermined camera scope is formed when said sensor component is lifted to a relatively highest position.

3. The method according to claim 1, wherein said camera system comprises a lens and a relatively largest camera scope of said predetermined camera scope is formed when a field of view of said lens is set at a relatively widest view angle.

4. The method according to claim 1, wherein said camera system comprises a lens and a relatively largest camera scope of said predetermined camera scope is formed when a focal length of said lens is a relatively smallest length.

5. The method according to claim 1, wherein said image scope has a long axis direction and a short axis direction, a long boundary of said adjustable camera scope is compared to said short axis direction of said image scope, and a short boundary of said adjustable camera scope is compared to said long axis direction of said image scope.

6. The method according to claim 5, wherein a manual operation of said fitting step is performed to fit said adjustable camera scope to said image scope of said object, and to select said short boundary of said adjustable camera scope covering a long axis of said object.

7. The method according to claim 6, wherein said long axis of said object is a long axis of a base of said digital data presenter.

8. The method according to claim 5, wherein said manual operation of said fitting step is performed to fit said adjustable camera scope to said image scope of said object, and to select said long boundary of said adjustable camera scope covering a short axis of said object.

9. The method according to claim 8, wherein said short axis of said object is a short axis of a base of said digital data presenter.

10. The method according to claim 5, wherein said long boundary and said short boundary of said adjustable camera scope are calculated based on a long axis and a short axis of a sensor component included in said camera system.

11. A system for fitting a camera scope to a object in an digital data presenter comprising:
a base;
a camera system positioned above said base and comprising a sensor component and a lens; and
a control system for controlling said digital data presenter and comprising an fitting controller for fitting said adjustable camera scope of said camera system to said object.

12. The system according to claim 11, wherein said fitting controller comprises a boundary interchangeable switch for switching between states of object boundary fitting, comprising:
a first state under which said camera scope fits a long axis of said object; and
a second state under which said camera scope fits a short axis of said object;
wherein said first state and said second state are switched by of said fitting controller.

13. The system according to claim 12, wherein said boundary interchangeable switch is a press button by pressing which said first state and said second state are alternatively switched.

14. The system according to claim 12, wherein said boundary interchangeable switch is a push button switch having a first position and a second position, wherein said first position represents said first state, and said second position represent said second state.
